(19) United States
(12) Patent Application Publication
(10) Pub. No.: US 2005/0193260 A1
(43) Pub. Date: Sep. 1, 2005

(54) Interrupt control program, recording medium, and interrupt control method

(75) Inventor: Takeharu Kato, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 10/849,361

(22) Filed: May 19, 2004

(30) Foreign Application Priority Data
Jan. 7, 2004 (JP) 2004-001934

(51) Int. Cl. G06F 11/00

(52) U.S. Cl. 714/34

(57) ABSTRACT

An interrupt control program that makes a computer execute accepting an interrupt from an interrupt controller, processing the interrupt accepted based on interrupt levels determined for various causes of interrupts, creating interrupt handling tasks for interrupt processing, corresponding to the various causes of interrupts, setting, in the interrupt handling tasks, task priorities reflecting the interrupt levels of the interrupts to be processed by the interrupt handling tasks created, determining the cause of the interrupt accepted, and activating one interrupt handling task, corresponding to the cause of interrupt determined, from among the interrupt handling tasks for which task priorities are set.

### BACKGROUND OF THE INVENTION

1) Field of the Invention

The present invention relates to an interrupt control program, a recording medium having recorded thereon the interrupt control program, and an interrupt control method, such that the interrupt handling is fast, and a number of modifications in the interrupt control program, required for adapting to a different interrupt controller, are less.

2) Description of the Related Art

In general, an operating system (OS) has incorporated therein a mechanism that responds to the occurrence of an external interrupt to start pre-designated processing, which is called “interrupt management”. In the field where real-time handling of interrupts is important as in a controller, it is necessary to control the order of handling interrupts based on their level of importance or significance; such control is called level-based interrupt control.

Typical representative schemes of level-based interrupt control are described below (see Masatake Nagai, Masaki Gondo, Tsutomu Sawada, “Practical Built-In OS Construction Techniques—Guide to Basic Technique RTOS Supporting Information Communications”, Kyoritsu Shuppan Co. Ltd., Nov. 1, 2001, p. 204-207):
(1) Level-based interrupt control scheme using an interrupt controller equipped with an interrupt priority control function; and
(2) Level-based interrupt control scheme using an interrupt mask pattern.

The interrupt controller equipped with an interrupt priority control function disables interrupts of priority levels lower than a preset level. Some central processing units (CPUs) have such an interrupt controller equipped with the interrupt priority function.

On the other hand, in CPUs with no such interrupt controller, there is incorporated an interrupt controller capable of realizing an interrupt mask ON/OFF control for each cause of interrupt, instead of exercising the level-based interrupt control. A known level-based interrupt control scheme that uses an interrupt controller capable of setting an interrupt mask for each interrupt source is a level-based interrupt control scheme that uses an interrupt mask pattern.

The scheme (1) realizes the interrupt priority control by hardware, whereas the scheme (2) realizes the control by software. In this specification, the interrupt priority and the interrupt level are defined as mentioned below.
Interrupt Priority: Interrupt priority that is set in the interrupt controller equipped with the interrupt priority control function
Interrupt Level: Interrupt priority set by a user

In the scheme (1) the interrupt priority and the interrupt level are handled in the same manner. In the scheme (2), no interrupt priority exists (because of no hardware support), and interrupt mask control based on the interrupt level is realized by software.

A description of both schemes will be given below, with reference to FIGS. 14A through 14C. FIG. 14A is a flowchart of the level-based interrupt control realized by the interrupt controller equipped with the interrupt priority control function.

If an interrupt occurs in peripheral equipment (step S401), the interrupt is posted to the interrupt controller (step S402).

The interrupt controller posts the interrupt to a CPU (step S403), which disables receiving interrupts (step S404). The process till this step is performed by hardware.

The OS saves the state (register/interrupt priority) at the time of occurrence of the interrupt (step S405), and determines the cause of the interrupt posted to the CPU (step S406). Based on the cause of interrupt, the OS sets the interrupt priority of the interrupt controller (step S407), and enables the CPU for interrupts (step S408).

The OS calls the appropriate interrupt handler for processing corresponding to the cause of interrupt (step S409), and upon completion of the interrupt handling, disables the CPU for interrupts (step S410), and restores the execution state (register/interrupt priority) saved at step S405 (step S411). The OS then resumes the process suspended by the occurrence of the interrupt, and enables the CPU for interrupts (step S412).

FIG. 14B is an explanatory diagram of the level-based interrupt control that uses a mask pattern. The mask pattern is a bit map that represents the cause of interrupt to be masked at each interrupt level. The diagram illustrates an example of a mask pattern in which priorities are assigned to three interrupts, timer, local area network (LAN), and disk, in that order (the highest priority to timer and the lowest to disk).

For example, the mask pattern corresponding to the highest interrupt level “interrupt level 3” masks all of interrupts—by the timer, the LAN and the disk thereby disabling all of the interrupts, and the mask pattern corresponding to the second highest interrupt level “interrupt level 2” masks the interrupts by the LAN and the disk, but enables only the interrupt by the timer.

Thus, using the interrupt controller capable of setting the interrupt mask ON/OFF state for each cause of interrupt, it is possible to implement the level-based interrupt control by establishing one-to-one correspondence between interrupt levels and mask patterns.

FIG. 14C is a flowchart of the procedure of the level-based interrupt control that uses the interrupt mask pattern. At the time of initialization of the OS, an interrupt to be masked for each interrupt level is computed from the interrupt levels of respective interrupts, and an interrupt mask pattern is created accordingly (step S421).

If an interrupt occurs in peripheral equipment (step S422), the interrupt is posted to the interrupt controller (step S423), which, in turn, posts the interrupt to the CPU (step S424). The CPU is then disabled for receiving interrupts (step S425). The process till this step is performed by hardware.

The OS saves the status (register/interrupt level) at the time of occurrence of the interrupt (step S426), and determines the cause of the interrupt (step S427). The OS detects the interrupt level from the cause of interrupt (step S428), and sets the mask pattern, corresponding to the interrupt level detected, in the interrupt controller (step S429).

The OS enables the CPU for interrupts (step S430), and executes the interrupt handling corresponding to the cause of interrupt (step S431). On completion of the interrupt handling, the OS disables the CPU for interrupts (step S432), and restores, in the interrupt controller, the mask pattern corresponding to the interrupt level before the interrupt occurred (step S433).

The OS restores the state saved in step S426 (step S434), resumes the process suspended by the interrupt, and enables the CPU for interrupts (step S435).

To ensure concurrent execution of interrupt handling in multi-processor environment, an OS such as Solaris executes the interrupt handling through an interrupt handling task corresponding to each interrupt, instead of directly calling the interrupt handler as an extension of the interrupt (see Jim Mauro, Richard McDougall, translated by Shu Fukumoto, Takefumi Hyodo, Kazushige Hosokawa, Tomoyuki Oomine, “Solaris Internals”, Pearson Education, Nov. 1, 2001, p. 39-42, and Jim Mauro, Richard McDougall, “Solaris Internals: Core Kernel Architecture”, Sun Microsystems Press).

With such conventional level-based interrupt control, however, the number of interrupt levels that can be set by the user depends on the number of interrupt priorities and the number of interrupt sources that can be masked in the interrupt controller. Consequently, for a changeover to another interrupt controller, modifications required in interrupt controller-dependent portions of the device driver or interrupt control program, increase.

### SUMMARY OF THE INVENTION

It is an object of the invention to at least solve the problems in the conventional technology.

An interrupt control program according to an aspect of the present invention makes a computer execute accepting an interrupt from an interrupt controller; processing the interrupt accepted based on interrupt levels determined for various causes of interrupts; creating interrupt handling tasks for interrupt processing, corresponding to the various causes of interrupts; setting, in the interrupt handling tasks, task priorities reflecting the interrupt levels of the interrupts to be processed by the interrupt handling tasks created; determining the cause of the interrupt accepted; and activating one interrupt handling task, corresponding to the cause of interrupt determined, from among the interrupt handling tasks for which task priorities are set.

A computer-readable recording medium according to another aspect of the present invention stores an interrupt control program that makes a computer execute accepting an interrupt from an interrupt controller; processing the interrupt accepted based on interrupt levels determined for various causes of interrupts; creating interrupt handling tasks for interrupt processing corresponding to the various causes of interrupts; setting, in the interrupt handling tasks, task priorities reflecting the interrupt levels of the interrupts to be processed by the interrupt handling tasks created; determining the cause of the interrupt accepted; and activating one interrupt handling task, corresponding to the cause of interrupt determined, from among the interrupt handling tasks for which task priorities are set.

An interrupt control method according to still another aspect of the present invention includes accepting an interrupt from an interrupt controller; processing the interrupt accepted based on interrupt levels determined for various causes of interrupts; creating interrupt handling tasks for interrupt processing, corresponding to the various causes of interrupts; setting, in the interrupt handling tasks, task priorities reflecting the interrupt levels of the interrupts to be processed by the interrupt handling tasks created; determining the cause of the interrupt accepted; and activating one interrupt handling task, corresponding to the cause of interrupt determined, from among the interrupt handling tasks for which task priorities are set.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 illustrates a system configuration for executing an interrupt control program according to a first embodiment of the present invention;

FIG. 2 is a functional block diagram of the interrupt control program according to the first embodiment;

FIG. 3 illustrates an example of cause-of-interrupt information stored in an interrupt level correspondence table;

FIG. 4 illustrates an example of interrupt handler information stored in an interrupt handler table;

FIG. 5 is a flowchart of the procedure executed by an interrupt initialization unit;

FIG. 6 is a flowchart of the procedure executed by an interrupt handling task;

FIG. 7 is a flowchart of the procedure executed by an interrupt acceptance unit and an interrupt exit unit;

FIG. 8 is an explanatory diagram of a concept of level-based interrupt control processing by an interrupt control program, according to a second embodiment;

FIG. 9 illustrates a device configuration for executing an interrupt control program according to the second embodiment;

FIG. 10 is a functional block diagram of the interrupt control program according to the second embodiment;

FIG. 11 illustrates an example of cause-of-interrupt information stored in the interrupt level correspondence table according to the second embodiment;

FIG. 12A is a flowchart of the procedure executed by an interrupt initialization unit according to the second embodiment;

FIG. 12B is a flowchart of a high-level interrupt initialization process shown in FIG. 12A;

FIG. 12C is a flowchart of a low-level interrupt initialization process shown in FIG. 12A;

FIG. 13A is a flowchart of the procedure executed by an interrupt acceptance unit and an interrupt exit unit according to the second embodiment;

FIG. 13B is a flowchart of a lowest-priority process shown in FIG. 13A;

FIG. 13C is a flowchart of a different priority process shown in FIG. 13A;

FIG. 14A is a flowchart of the procedure of the level-based interrupt control by an interrupt controller equipped with an interrupt priority control function;

FIG. 14B is an explanatory diagram of the level-based interrupt control that uses a mask pattern; and

FIG. 14C is a flowchart of the procedure of the level-based interrupt control that uses an interrupt mask pattern.

### DETAILED DESCRIPTION

Exemplary embodiments of an interrupt control program and a recording medium having recorded thereon the interrupt control program, and an interrupt control method will be described below with reference to the accompanying drawings.

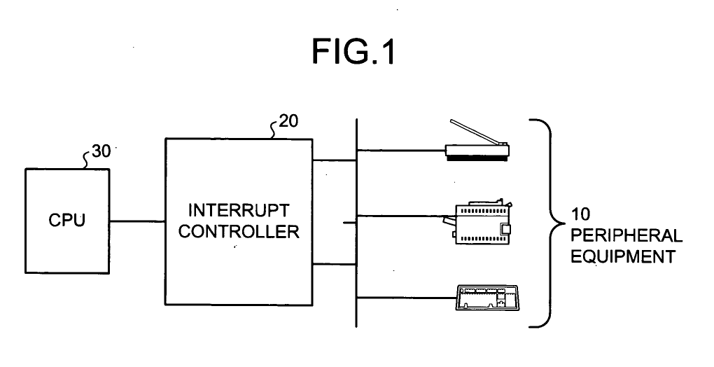

FIG. 1 illustrates a system configuration for executing an interrupt control program according to a first embodiment of the present invention. The system includes a plurality of peripheral equipment 10, an interrupt controller 20, and a CPU 30.

The peripheral equipment 10 include a disk, a printer, a LAN, etc., which are connected to the interrupt controller 20 and, by generating an interrupt, post events such as I/O completion, data reception, or the like to the CPU 30.

The interrupt controller 20 receives an interrupt from the peripheral equipment 10 and posts the interrupt to the CPU 30. The interrupt controller 20 controls interrupts based on individual interrupt masks. That is, the interrupt controller 20 controls an ON/OFF state of the interrupt mask for each cause of interrupt.

The CPU 30 executes an OS that includes an interrupt control program and applications, and function of enabling/disabling interrupts posted by the interrupt controller 20.

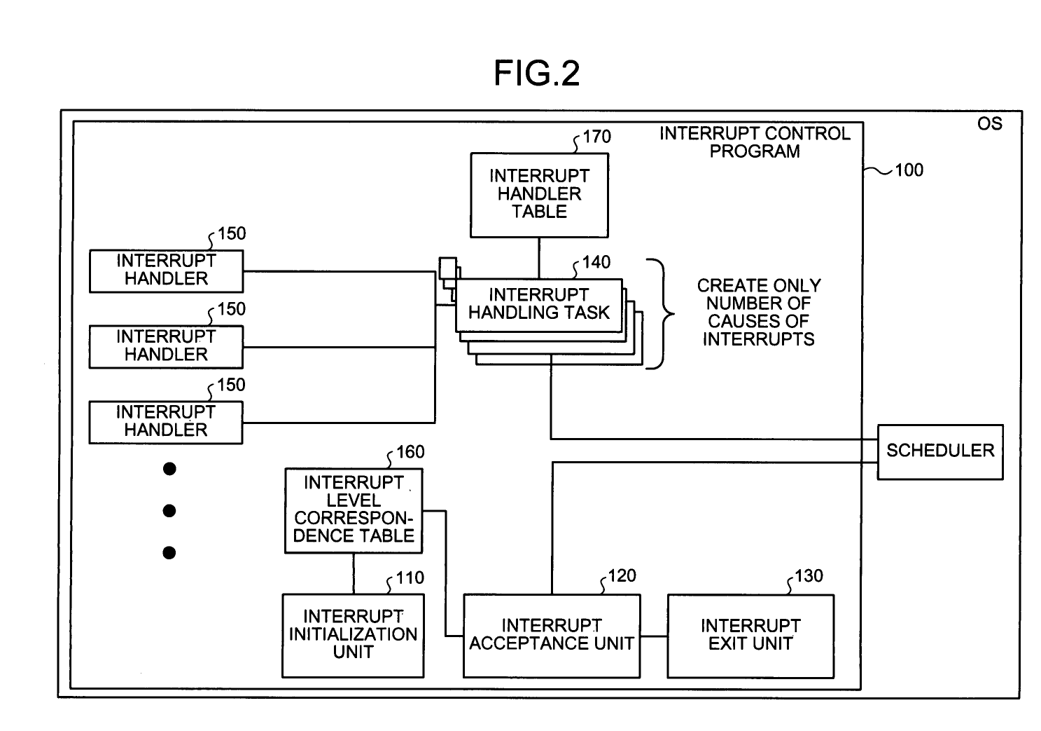

FIG. 2 is a functional block diagram of the interrupt control program according to the first embodiment. The interrupt control grogram 100 includes an interrupt initialization unit 110, an interrupt acceptance unit 120, an interrupt exit unit 130, interrupt handling tasks 140, interrupt handlers 150, an interrupt level correspondence table 160, and an interrupt handler table 170.

The interrupt initialization unit 110 initializes the interrupt control program; and more specifically, it initializes the interrupt level correspondence table 160 and creates the interrupt handling tasks 140.

The interrupt acceptance unit 120 records the occurrence of an interrupt from peripheral equipment and prepares for interrupt handling. Specifically, the interrupt acceptance unit 120 stores the execution state at the time of occurrence of an interrupt, determines the cause of the interrupt, and activates the interrupt handling task 140 corresponding to the cause of interrupt.

The interrupt exit unit 130 completes the interrupt handling and returns to the execution state suspended when the interrupt occurred. More specifically, the interrupt exit unit 130 restores the execution state at the time of occurrence of an interrupt.

Each interrupt handling task 140 performs interrupt handling corresponding to the cause of interrupt; and more specifically, it activates the interrupt handler 150 to perform interrupt handling. The interrupt handling tasks 140 are created by the interrupt initialization unit 110 and the number of interrupt handling tasks 140 corresponds to that of causes of interrupts, and the interrupt handler tasks 140 each activate one of the interrupt handlers 150 corresponding to the causes of interrupts, respectively, to perform interrupt handling.

Each of the interrupt handlers 150 are a processing unit that is invoked by the interrupt task 140 and actually performs interrupt handling. The interrupt handlers 150 are created by a developer of a device driver and are previously stored in the OS.

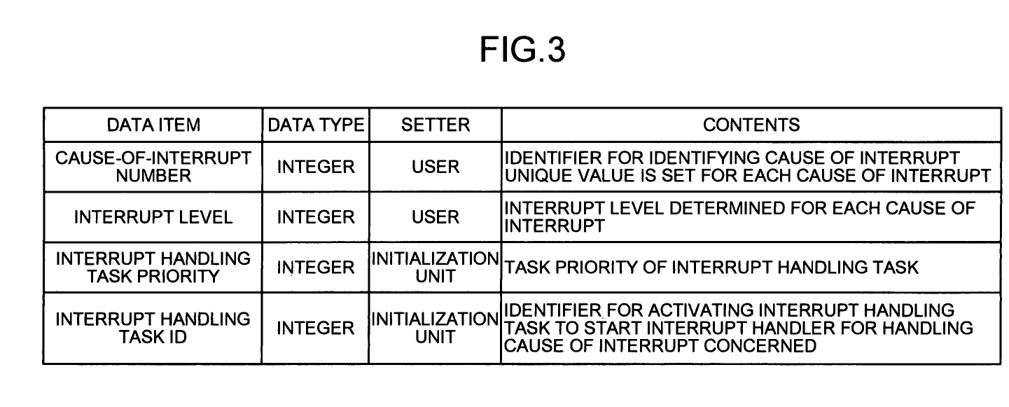

The interrupt level correspondence table 160 stores, as cause-of-interrupt information, information about the interrupt level and the interrupt handling task 140, etc. for each cause of interrupt. FIG. 3 illustrates an example of cause-of-interrupt information stored in the interrupt level correspondence table 160.

The cause-of-interrupt information includes a cause-of-interrupt number identifying each cause of interrupt, an interrupt level determined for each cause of interrupt; an interrupt handling task priority that is the priority of the interrupt handling task 140 that performs interrupt handling corresponding to a cause of interrupt, and an interrupt handling task ID for identifying the interrupt handling task 140.

The interrupt initialization unit 110 assigns the interrupt handling task priority, which reflects the interrupt level, to each interrupt handling task 140. That is, the interrupt handing task 140 corresponding to the cause of interrupt of a higher interrupt level, is assigned a higher priority. Whereas, the interrupt handling task 140 corresponding to the cause of interrupt of a lower interrupt level, is assigned a lower priority.

By assigning priority to the interrupt handling tasks 140 based on the interrupt levels, it is possible to implement level-based interrupt control by the task priority control of the interrupt handling tasks 140.

The number of causes of interrupts and the number of interrupt levels are set by the user at the time of system configuration, and the interrupt handling task IDs are set by the interrupt initialization unit 110. The data type of the cause-of-interrupt numbers, the interrupt levels, the interrupt handling task priorities, and the interrupt handling tasks IDs is integer.

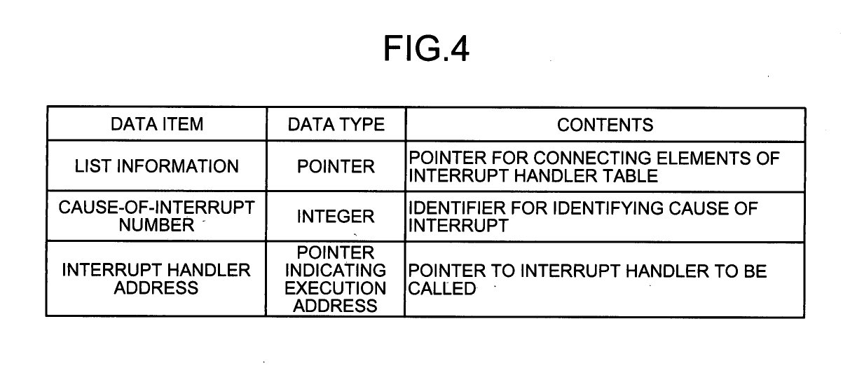

The interrupt handler table 170 shown in FIG. 2 stores, as interrupt handler information, information about the interrupt handlers 150 to be activated corresponding to causes of interrupts, for each cause of interrupt. FIG. 4 illustrates an example of interrupt handler information stored in the interrupt handler table 170.

The interrupt handler table 170 is a list that includes a plurality of the interrupt handler information as its elements. As shown in FIG. 4, each element contains list information, the cause-of-interrupt number, and an interrupt handler address that is an address of the interrupt handler 150. The list information is a pointer for connecting respective elements of the list-structured interrupt handler table 170.

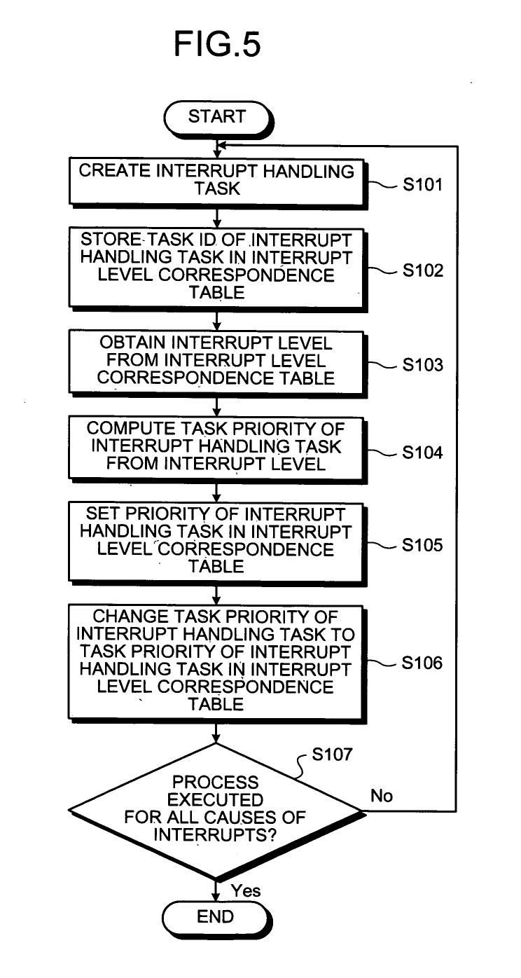

A procedure executed by the interrupt initialization unit 110 will be described next with reference to the flowchart in FIG. 5. The interrupt initialization unit 110 creates the interrupt handling task 140 for calling the interrupt handler 150 (step S101), and stores the task ID of the interrupt handling task 140 created, in the interrupt level correspondence table 160, in correlation with one cause of interrupt (step S102).

The interrupt initialization unit 110 obtains the interrupt level of the cause of interrupt for which the task ID is stored, from the interrupt level correspondence table 160 (step S103), and computes the task priority of the interrupt handling task 140 from the interrupt level obtained (step S104).

Specifically, the interrupt initialization unit 110 computes the task priority such that the interrupt handling task 140 for the interrupt of high level is given a higher priority than the interrupt handling task 140 for the interrupt of low level.

The interrupt initialization unit 110 sets the computed value as the interrupt handling task priority in the interrupt level correspondence table 160 (step S105), and changes the priority of the created interrupt handling task 140 to the priority set in the level correspondence table 160 (step S106).

The interrupt initialization unit 110 then determines whether interrupt handling tasks have been created for all causes of interrupts (step S107). If not, the interrupt initialization unit 110 repeats step S101 through step S106 for the next cause of interrupt; and when all causes of interrupts are served, the initialization unit 110 terminates the procedure.

As described above, the interrupt initialization unit 110 sets the priorities of the interrupt handling tasks 140 with respect to the interrupt levels of the causes of interrupts. Thus, priority control of the interrupt handling tasks 140 can be implemented as a substitute for level-based interrupt priority control.

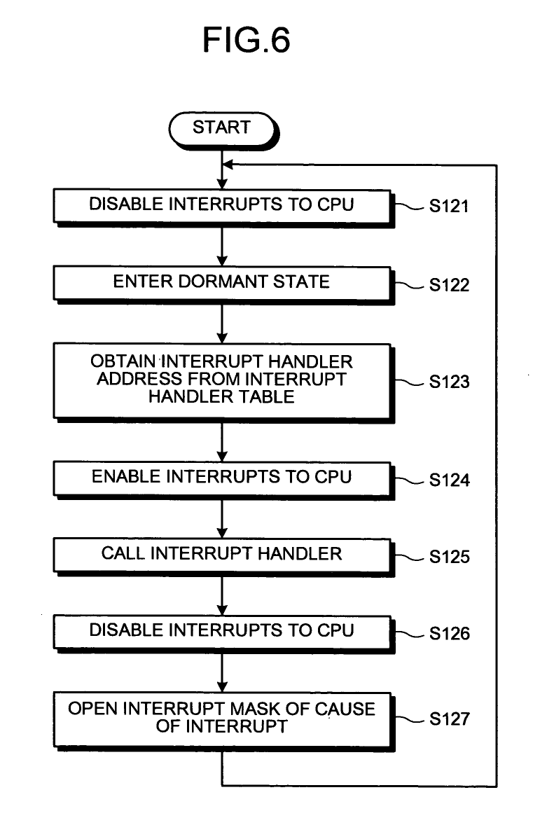

The procedure executed by the interrupt handling task 140 will be described with reference to the flowchart in FIG. 6. The interrupt handling task 140, after being created by the interrupt initialization unit 110, disables interrupts to the CPU 30 (step S121), and enters its dormant state (step S122).

When an interrupt occurs, the interrupt acceptance unit 120 activates the interrupt handling task 140, and the scheduler places the interrupt handling task 140 in the execution state based on the task priority. The interrupt handling task 140 obtains, from the interrupt handler table 170, the address of the interrupt handler 150 that is supposed to handle the interrupt that occurred (step S123), and enables interrupts to the CPU 30 (step S124), and invokes the interrupt handler 150 (step S125).

When the interrupt handling by the interrupt handler 150 is complete, the interrupt handling task 140 disables interrupts to the CPU 30 (step S126), and releases the interrupt mask for the cause of interrupt handled (step S127), and returns to step S121.

Thus, when activated by the interrupt acceptance unit 120, the interrupt handling task 140 calls the interrupt handler 150 for interrupt handling, and hence, the task priority control can be implemented as a substitute for the level-based interrupt priority control.

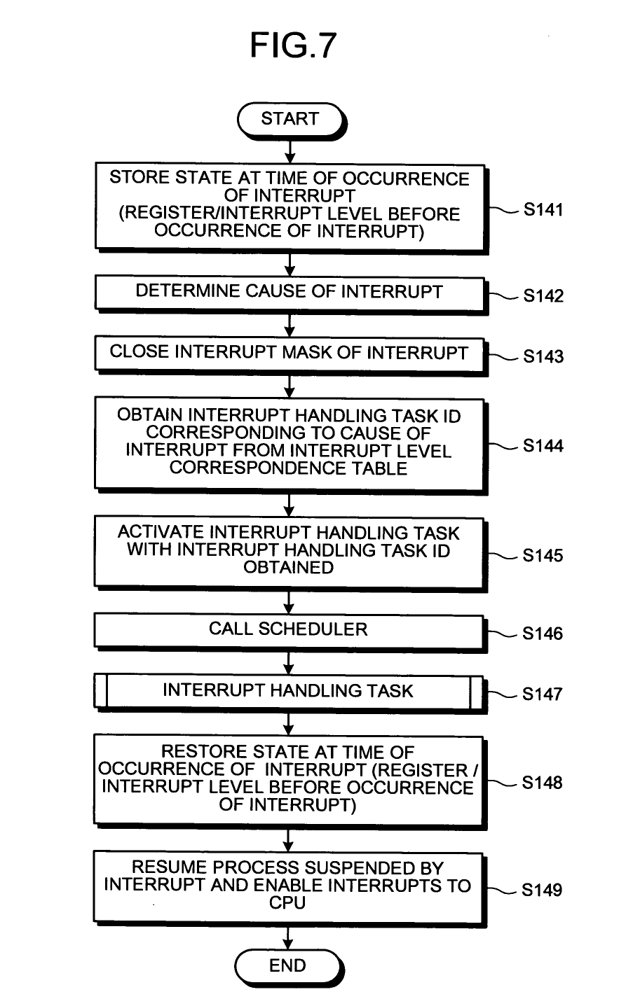

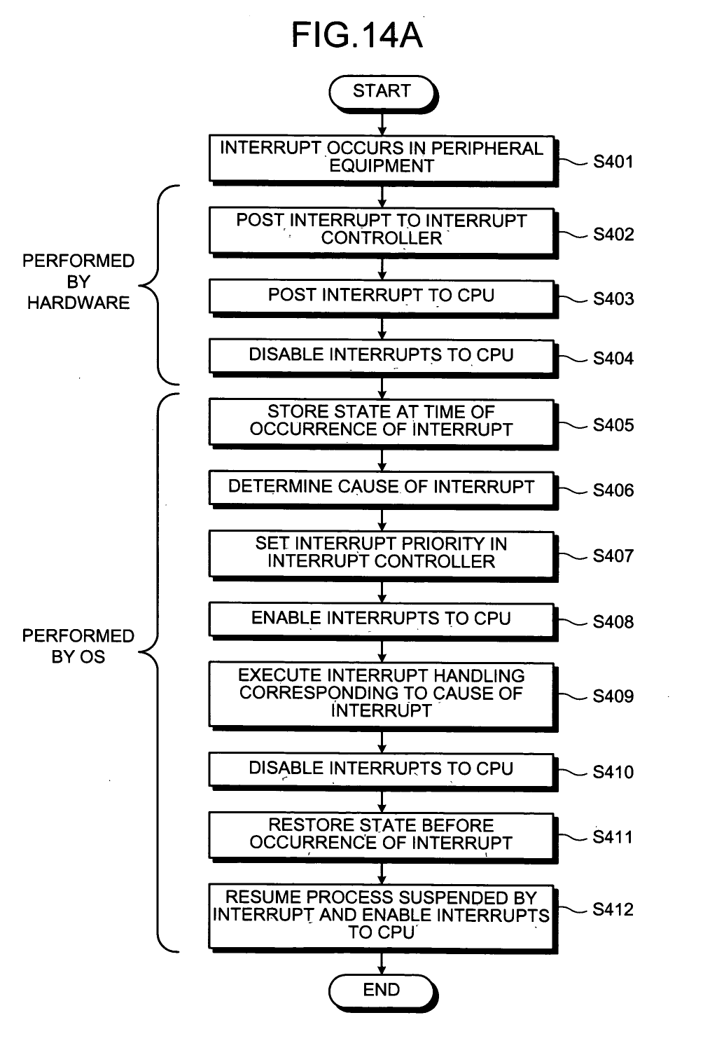

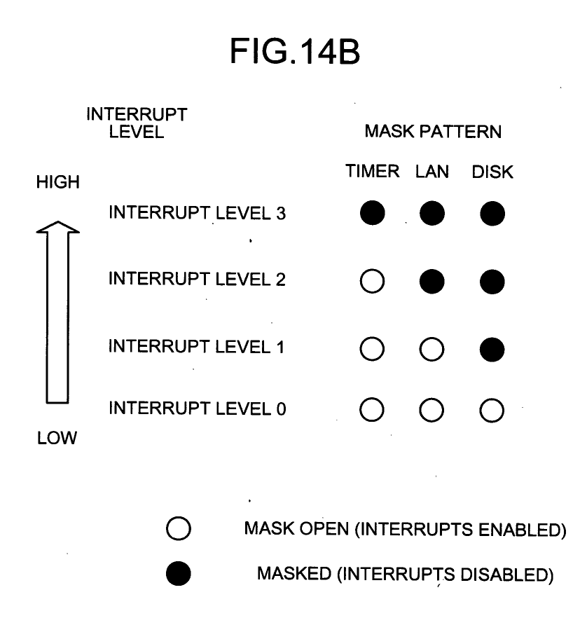

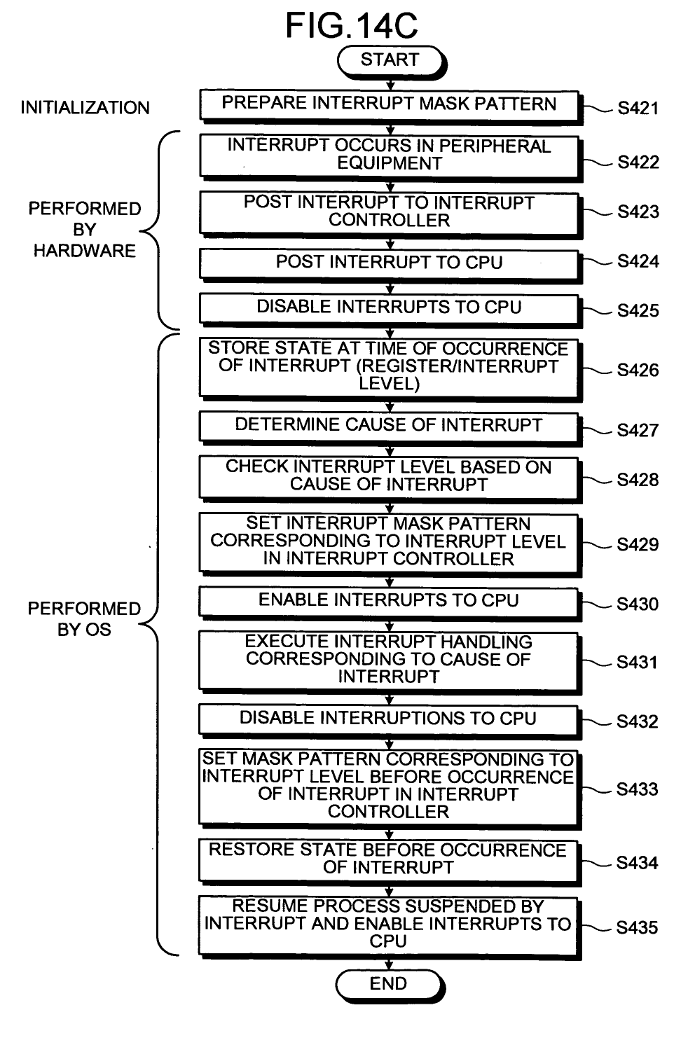

Referring next to FIG. 7, a procedure executed by the interrupt acceptance unit 120 and the interrupt exit unit 130 will be described next. The interrupt acceptance unit 120 executes this procedure after the hardware process illustrated in FIG. 14C.

As shown in FIG. 7, the interrupt acceptance unit 120 stores the execution state (register/interrupt level) when the interrupt occurs (step S141), and determines the cause of interrupt (step S142).

The interrupt acceptance unit 120 masks the interrupt that occurred (step S143), obtains the corresponding interrupt handling task ID from the interrupt level correspondence table 160 (step S144), and activates the interrupt handling task 140 with the interrupt handling task ID obtained (step S145).

The interrupt acceptance unit 120 calls the scheduler (step S146), and control passes to the interrupt handling task 140 (step S147). After the process executed by the interrupt handling task 140 is complete, control returns to the interrupt acceptance unit 120, which transfers control to the interrupt exit unit 130.

The interrupt exit unit 130 restores the execution state (register/interrupt level) that was suspended when the interrupt occurred (step S148), and resumes the suspended process, while at the same time enabling interrupts to the CPU 30 (step S149).

As described above, according to the first embodiment, the interrupt initialization unit 110 creates interrupt handling tasks 140 for handling interrupts; the interrupt levels determined for the interrupts to be handled by the interrupt handling tasks 140 are reflected on the interrupt priorities; and, when accepting an interrupt, the interrupt acceptance unit 120 activates the interrupt handling task 140 for handling the interrupt accepted, and passes control therefrom to the scheduler. Therefore, the priority control of the interrupt handling tasks 140 can be implemented instead of the level-based interrupt priority control using the mask pattern. Consequently, the number of interrupt levels can be set irrespective of the priority control specifications of the interrupt controller.

Accordingly, in the interrupt control program 100, the number of program elements affected by the priority control specifications of the interrupt controller reduces. Consequently, the number of modifications in the interrupt control program 100, for adapting to a different interrupt controller reduces, and hence, cost of program development reduces.

In the first embodiment, the interrupt controller 20 realizes interrupt control using individual interrupt masks. However, an interrupt controller equipped with the interrupt priority control function as well as the function of individually masking interrupts, may be used.

As a second embodiment of the present invention, an interrupt control program that is a combination of the interrupt control scheme described in the first embodiment and the interrupt priority control function is described below. Such a method ensures compatibility between level-based interrupt control that uses an arbitrary number of interrupt levels and fast priority-based interrupt control that uses the interrupt priority control function.

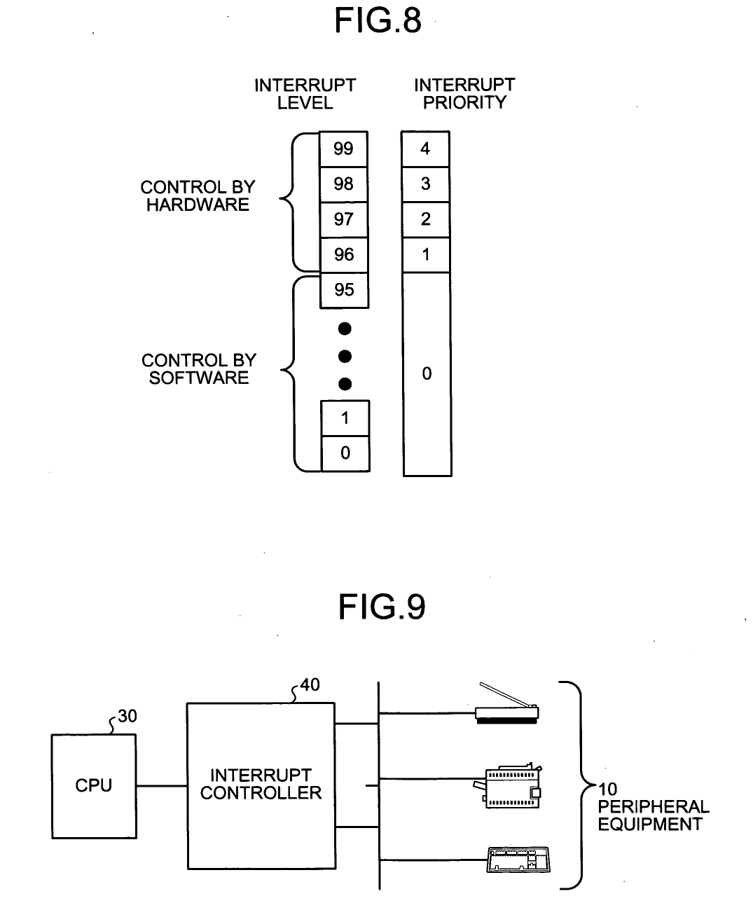

FIG. 8 is an explanatory diagram of the concept of level-based interrupt control processing by an interrupt control program, according to the second embodiment. The interrupt control program according to the second embodiment is executed in a device provided with an interrupt controller equipped with a five-level interrupt-priority control function (interrupt priorities 0 through 4).

As shown in FIG. 8, 100 interrupt levels, 0 through 99, can be set. The interrupt control program according to the second embodiment controls the highest four (levels 99 to 96) interrupt levels by hardware.

That is, the interrupt controller realizes the interrupt level control for the interrupt levels 99 to 96 respectively corresponding to interrupt priorities 4 to 1 of the interrupt controller.

The interrupts of the interrupt level 95 and below all correspond to the interrupt priority 0 of the interrupt controller, and the interrupt level control is realized by software using the scheme described in the first embodiment.

Thus, the interrupt control program according to the second embodiment uses the interrupt priority control function for control of the interrupts at the higher interrupt levels, and the scheme in the first embodiment for control of the interrupts at the lower interrupt levels. Hence, an arbitrary number of interrupt levels can be set, as well as, speed of handling interrupts at high interrupt levels increases.

FIG. 9 illustrates a device configuration for executing an interrupt control program according to the second embodiment. The device has an interrupt controller 40 in place of the interrupt controller 20 of FIG. 1.

The interrupt controller 40 is equipped with the interrupt priority control function. The interrupt controller 40 includes a function of posting an interrupt received from the peripheral equipment 10 to the CPU 30, a function of setting an interrupt mask for each cause of interrupt, and a function of disabling interrupts of priorities lower than a specified interrupt priority.

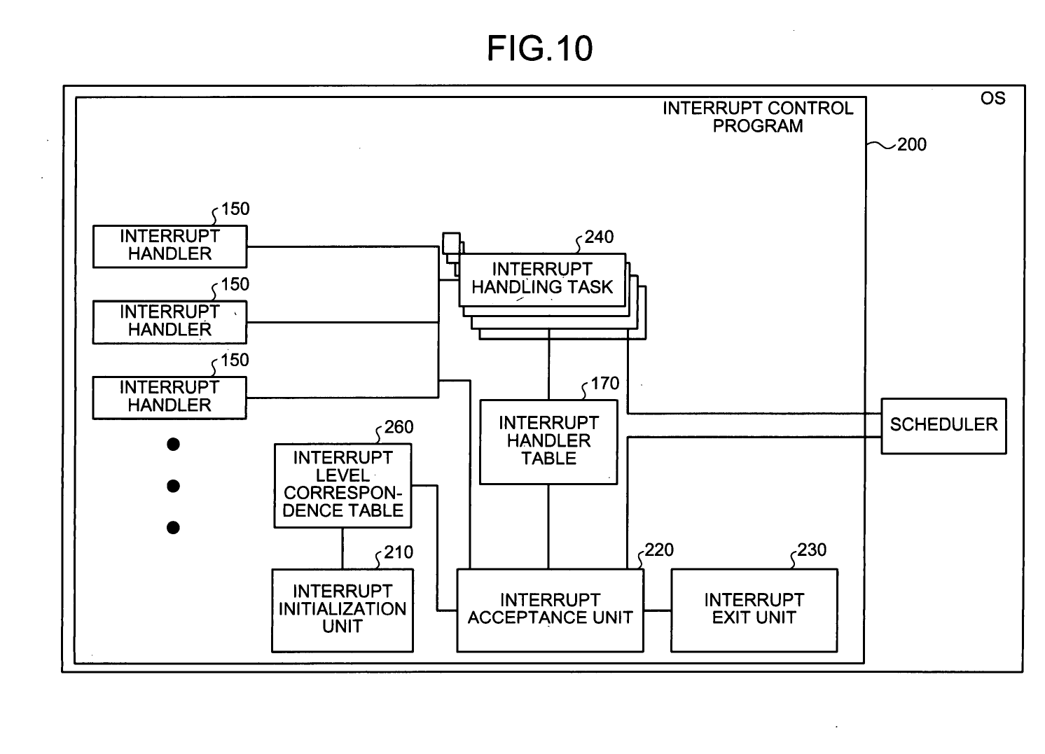

FIG. 10 is a functional block diagram of the interrupt control program according to the second embodiment. In FIG. 10, the units corresponding to those in FIG. 2 are designated by like reference numerals and detailed description thereof is omitted.

The interrupt control program 200 includes an interrupt initialization unit 210, an interrupt acceptance unit 220, an interrupt exit unit 230, interrupt handling tasks 240, interrupt handlers 150, an interrupt level correspondence table 260, and an interrupt handler table 170.

The interrupt initialization unit 210 initializes the interrupt control program; the interrupt acceptance unit 220 accepts and processes an interrupt posted by the interrupt controller 40; and the interrupt exit unit 230, after interrupt handing, performs processing for returning to the execution state before the occurrence of interrupt.

The interrupt handling tasks 240 perform interrupt processing corresponding to causes of interrupts, like the interrupt handling tasks 140. The number of tasks created is less than the number of causes of interrupts, and for processing some of the high level causes of interrupts, the interrupt acceptance unit 220 directly calls the interrupt handlers 150.

The interrupt level correspondence table 260 stores, in addition to the cause-of-interrupt information stored in the interrupt level correspondence table 160, interrupt priorities set in the interrupt controller 40.

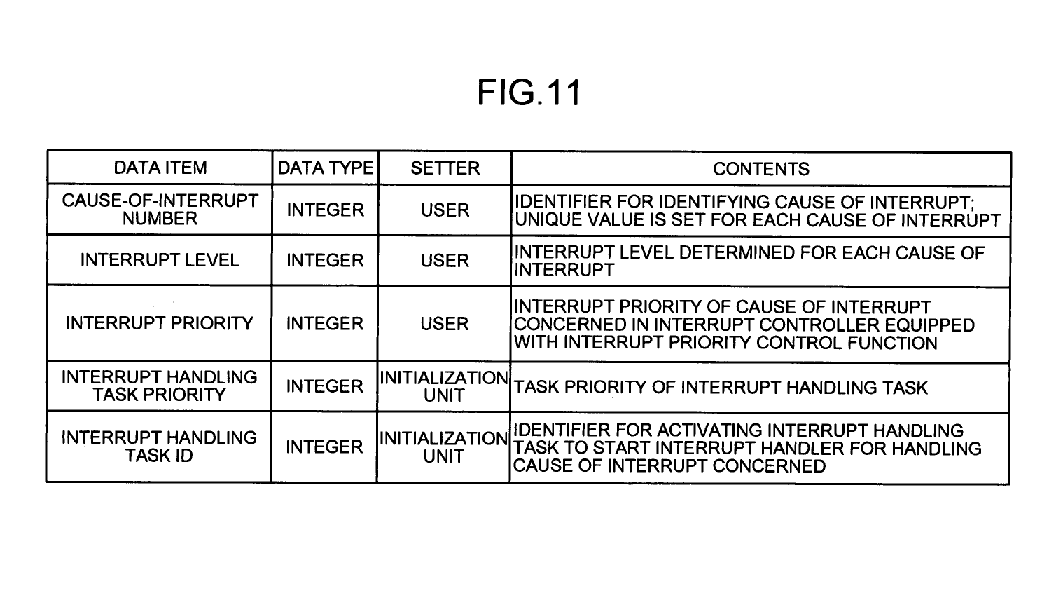

FIG. 11 illustrates an example of cause-of-interrupt information stored in the interrupt level correspondence table 260. The cause-of-interrupt information includes the interrupt priority in addition to with the cause-of-interrupt information shown in FIG. 3. A user sets the interrupt priority, which is of integer type.

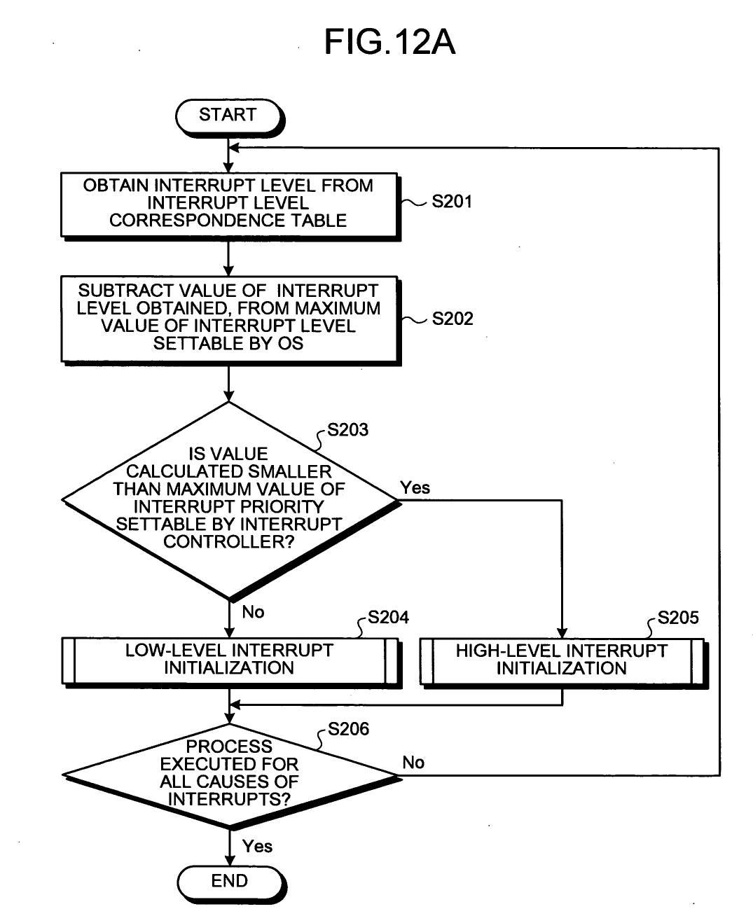

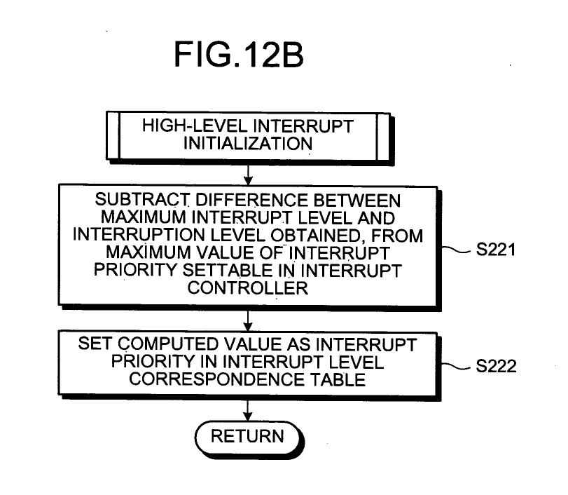

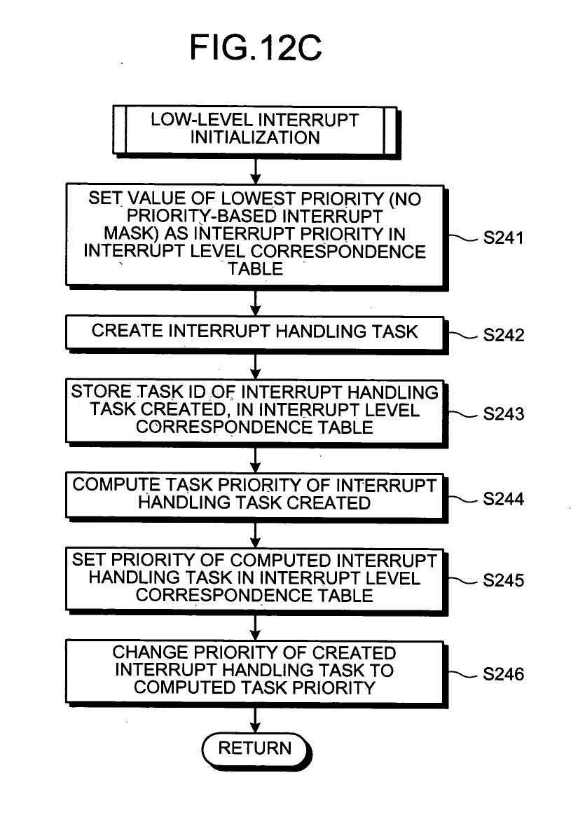

A procedure executed by the interrupt initialization unit 210 according to the second embodiment will be described next with reference to the flowchart in FIG. 12A. The interrupt initialization unit 210 obtains one interrupt level of the cause of interrupt from the interrupt level correspondence table 260 (step S201).

The interrupt initialization unit 210 subtracts the value of the interrupt level obtained, from the maximum value of interrupt level settable by the OS (step S202), and determines whether the value calculated is smaller than the maximum value of interrupt priority settable by the interrupt controller 40 (step S203).

If the value calculated is greater than the maximum value of interrupt priority, the interrupt level is a low level for which the interrupt controller 40 cannot provide interrupt priority control. Therefore, the interrupt initialization unit 210 performs low-level interrupt initialization (step S204). However, if the value calculated is smaller than the maximum value of interrupt priority, the interrupt level is a high level for which the interrupt controller 40 can provide interrupt priority control. Therefore, the interrupt initialization unit 210 performs high-level interrupt initialization (step S205).

For example, if the interrupt level obtained from the interrupt level correspondence table 260 is “96”, the value “3” computed by subtracting “96” from the maximum interrupt level settable by the OS, “99”, is smaller than the maximum interrupt priority “4”. Consequently, the interrupt initialization unit 210 performs the high-level interrupt initialization processing.

The interrupt initialization unit 210 then determines whether the process has been executed for all causes of interrupts (step S206). If not, the initialization unit 210 returns to step S201 to perform processing the next cause of interrupt. If the process has been executed for all causes of interrupts, the procedure ends.

The high-level interrupt initialization process (step S205 of FIG. 12A) is described next, with reference to the flowchart in FIG. 12B.

In the high-level interrupt initialization, the difference between the maximum value of the interrupt level and the interrupt level obtained from the interrupt level correspondence table 260 is subtracted from the maximum value of the interrupt priority settable by the interrupt controller 40 (step S221). The computed value is set as the interrupt priority in the interrupt level correspondence table 260 (step S222).

For example, when the interrupt level obtained from the interrupt level correspondence table 260 is “96”, the level difference between this value and the maximum value of interrupt level “99” is “3.” The level difference is subtracted from the maximum value of interrupt priority “4”, to obtain “1”, which is set as the interrupt priority in the interrupt level correspondence table 260.

Thus, the high-level interrupt initialization process computes the interrupt priority of the cause of interrupt whose interrupt level is higher than “96” and sets the interrupt priority in the interrupt level correspondence table 260. Therefore, it is possible to obtain, from the cause of interrupt, the interrupt priority that the interrupt acceptance unit 220 sets in the interrupt controller 40.

The low-level interrupt initialization process (step S204 of FIG. 12A) is described next, with reference to the flowchart in FIG. 12C.

In the low-level interrupt initialization, the value of the lowest priority “0” (no priority-based interrupt mask) is set as the interrupt priority in the interrupt level correspondence table 260 (step S241). The interrupt handling task 240 that calls the corresponding interrupt handler 150 is created (step S242).

The task ID of the interrupt handling task 240 created is stored in the interrupt correspondence table 260 (step S243). The task priority of the interrupt handling task 240 is computed from the interrupt level of the cause of interrupt corresponding to the stored task ID (step S244).

In the low-level initialization, the task priority is computed so that the task priority of the interrupt handling task 240 that handles the cause of interrupt of a high interrupt level is higher than the task priority of the interrupt handling tasks 240 that handles the causes of interrupts of lower interrupt levels.

The value of the interrupt handling task priority thus obtained is set in the interrupt level correspondence table 260 (step S245), and the priority of the interrupt handling task 240 created is changed to the task priority set in the interrupt level correspondence table 260 (step S246).

As described above, in the low-level interrupt initialization the interrupt priority for the cause of interrupt with interrupt level lower than “96” is set as “0” in the interrupt level correspondence table 260, and the interrupt handling task 240 for handling such interrupt is created and stored in the interrupt level correspondence table 260. Hence, as described later, when an interrupt with interrupt level lower than “96” occurs, it is possible for the interrupt acceptance unit 220 to set the lowest priority in the interrupt controller 40 and perform interrupt handling using the interrupt handling task 240 stored.

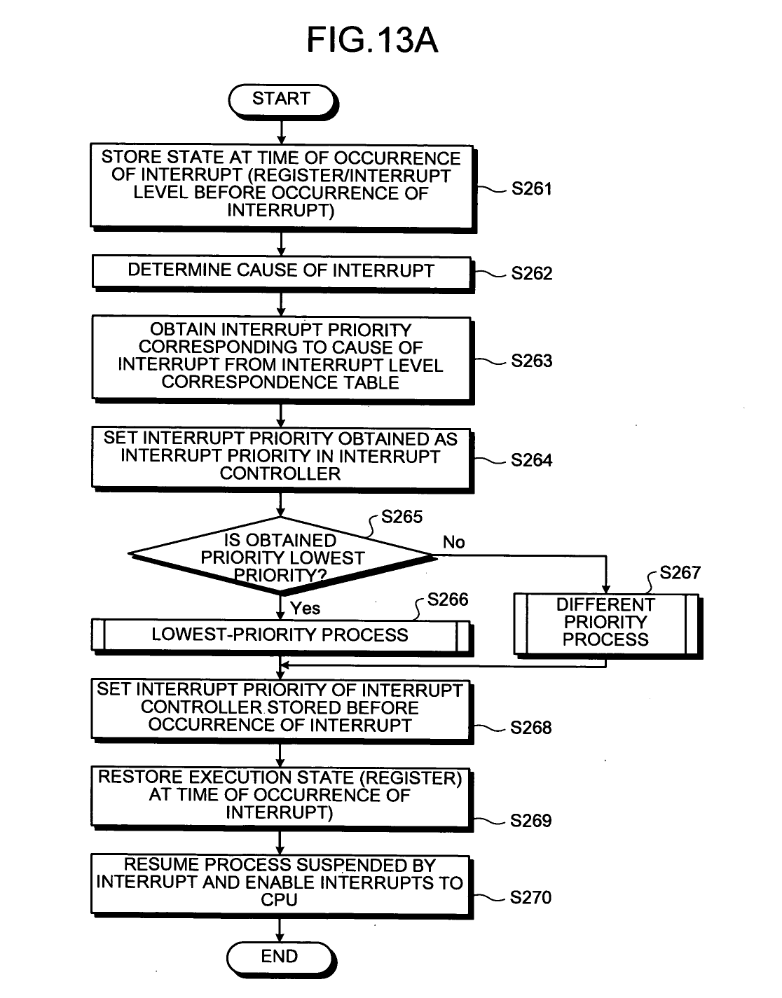

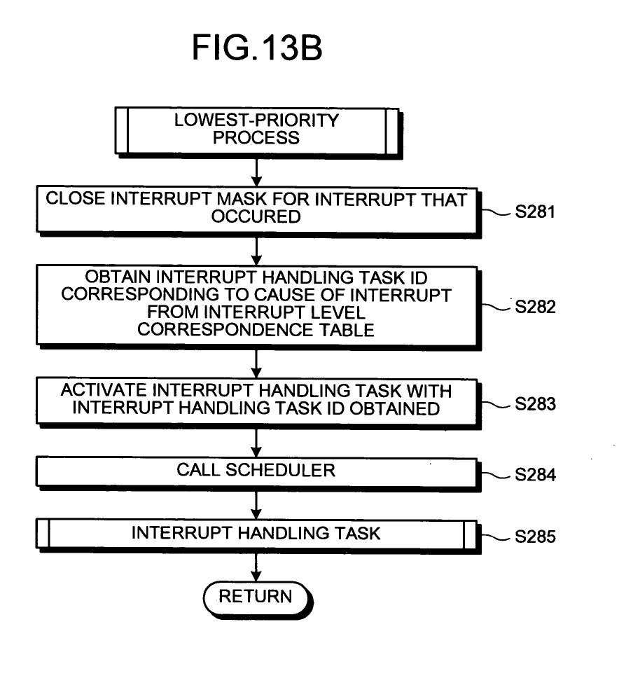

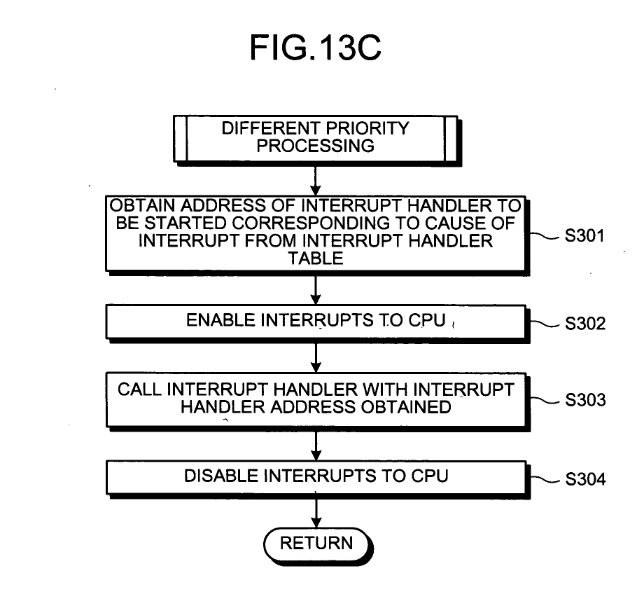

FIG. 13A is a flowchart of the procedure executed by the interrupt acceptance unit 220 and the interrupt exit 230. The interrupt acceptance unit 220 executes this procedure after the hardware process shown in FIG. 14C.

As shown in FIG. 13A, the interrupt acceptance unit 220 stores the execution state (register/interrupt level) when the interrupt occurs (step S261).

The interrupt acceptance unit 220 determines the cause of the interrupt (step S262), obtains the interrupt priority corresponding to the cause of interrupt from the interrupt level correspondence table 260 (step S263), and sets the interrupt priority in the interrupt controller 40 (step S264).

The interrupt acceptance unit 220 determines whether the priority obtained is the lowest priority (step S265), and if so, performs lowest-priority process using the corresponding interrupt handling task 240 (step S266). However, if the interrupt priority obtained is not the lowest priority, the interrupt acceptance unit 220 directly invokes the corresponding interrupt handler 150 to perform a different priority processing (step S267).

Upon completion of the interrupt handling, the interrupt acceptance unit 220 passes control to the interrupt exit unit 230. The interrupt exit unit 230 loads the interrupt priority that existed before the interrupt occurred (stored in step S261), into the interrupt controller 40 (step S268), restores the execution state (register) at the time of occurrence of the interrupt (step S269), and resumes the process suspended by the interrupt, while at the same time enabling interrupts to the CPU 30 (step S270).

As described above, the interrupt acceptance unit 220 performs interrupt handling using the interrupt handling task 240 or directly invokes the corresponding interrupt handler 150 to interrupt processing, depending on whether the interrupt priority is the lowest one. Thus, it is possible to provide compatibility between the level-based interrupt control capable of using an arbitrary number of interrupt levels and fast priority-based interrupt control with the interrupt priority control function.

With reference to FIG. 13B, the lowest-priority process (step S266) in FIG. 13A is described below.

In the lowest-priority processing, an interrupt mask for the interrupt that occurred is closed (step S281), and the interrupt handing task ID corresponding to the cause of the interrupt is obtained from the interrupt level correspondence table 260 (step S282).

The interrupt handling task ID is used to activate the corresponding interrupt handling task 240 (step S283), then the scheduler is invoked (step S284), and control is transferred from the lowest-priority process to the interrupt handling task 240 (step S285).

The different priority process (step S267) in FIG. 13A will be described next with reference to the flowchart in FIG. 13C.

As shown in FIG. 13C, the different priority process obtains, from the interrupt handler table 170, the address of the interrupt handler 150, that is to be activated, corresponding to the cause of interrupt (step S301). The different priority process enables interrupts to the CPU 30 (step S302), and invokes the corresponding interrupt handler 150 using the address of the interrupt handler obtained in step S301 (step S303). The process then disables interrupts to the CPU 30, and returns (step S304).

As described above, in the second embodiment, the interrupt initialization unit 210 assigns a priority level except the lowest priority “0”, in descending order, to each of a predetermined number (one less than the number of priority levels settable by the interrupt controller 40; 4 in this case) of causes of interrupts, in the interrupt level correspondence table 260 (in this case, interrupt priorities 4 to 1 are assigned to the interrupt levels 99 to 96). Upon occurrence of an interrupt, the interrupt acceptance unit 220 determines whether the priority of the cause of the interrupt is the lowest priority. If not, the interrupt acceptance unit 220 directly invokes the corresponding interrupt handler 150 to handle the interrupt. Accordingly, it is possible to set an arbitrary number of interrupt levels independent of the number of priority levels settable by the interrupt controller 40, and hence, speed up interrupt handling for the predetermined number of interrupts.

The interrupt control program of the present invention may be stored in a computer-readable medium that includes portable recording media such as an optical disc, a flexible disc, a hard disc, and the like, and also transmission media such as a network for temporarily recording data therein. A CPU may execute the interrupt control program to realize the functions therein.

According to an aspect of the present invention, it is possible to reduce the number of modifications in the interrupt control program, required for adapting to a different interrupt controller, and thereby to reduce cost of program development.

Moreover, it is possible to speed up handling of interrupts of high interrupt level.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. An interrupt control program that makes a computer execute:
accepting an interrupt from an interrupt controller;
processing the interrupt accepted based on interrupt levels determined for various causes of interrupts;
creating interrupt handling tasks for interrupt processing, corresponding to the various causes of interrupts;
setting, in the interrupt handling tasks, task priorities reflecting the interrupt levels of the interrupts to be processed by the interrupt handling tasks created;
determining the cause of the interrupt accepted; and
activating one interrupt handling task, corresponding to the cause of interrupt determined, from among the interrupt handling tasks for which task priorities are set.

2. The interrupt control program according to claim 1, wherein
the creating includes assigning interrupt priorities to the causes of interrupts based on the interrupt levels, and creating the interrupt handling task only for the cause of interrupt having a lowest priority assigned thereto,
the determining includes determining whether the interrupt priority assigned to the cause of interrupt determined is the lowest priority, and if the interrupt priority assigned is not the lowest priority, then the processing includes directly invoking an interrupt handler corresponding to the interrupt accepted, and
the activating includes activating the one interrupt handling task, if it is determined at the determining that the interrupt priority assigned is the lowest priority.

3. The interrupt control program according to claim 1, wherein the creating and the setting are an initialization step of creating the interrupt handling tasks and setting the task priorities.

4. The interrupt control program according to claim 1, further making the computer execute:
storing in correlated form the interrupt handling tasks created and the causes of interrupts corresponding to the interrupt handling tasks created, in an interrupt handler table, and wherein
the activating includes obtaining the one interrupt handling task from the interrupt handler table, and then activating the interrupt handling task obtained.

5. The interrupt control program according to claim 1, wherein the processing includes
invoking an interrupt handler corresponding to the cause of interrupt determined at the determining, wherein the invoking is performed by the one interrupt handling task activated.

6. The interrupt control program according to claim 5, further making the computer execute:
storing in correlated form the causes of interrupts and the interrupt handlers corresponding to the causes of interrupts in an interrupt handler table, and
obtaining an interrupt handler from the interrupt handler table, and then invoking the interrupt handler obtained to process the interrupt, wherein the obtaining and the invoking are performed by the interrupt handling task activated.

7. The interrupt control program according to claim 1, wherein the activating is followed by transferring control to a scheduler.

8. The interrupt control program according to claim 1, wherein the creating is followed by making the interrupt handling task created enter a dormant state and wait for being activated.

9. The interrupt control program according to claim 2, wherein
the creating includes assigning interrupt priorities in descending order of the interrupt level, and if a number of interrupt levels is greater than a number of priorities of the interrupt controller, assigning one interrupt priority to a plurality of causes of interrupts that have different interrupt levels, and
the processing performed by the interrupt handling task includes processing a plurality of interrupt levels for each interrupt priority.

10. The interrupt control program according to claim 2, wherein
the creating includes storing in correlated form the interrupt priorities assigned to the causes of interrupts and the causes of interrupts in an interrupt priority table, and
the determining includes determining whether the interrupt priority assigned to the cause of interrupt determined is the lowest priority, by referring to the interrupt priority table.

11. A computer-readable recording medium that stores an interrupt control program that makes a computer execute:
accepting an interrupt from an interrupt controller;
processing the interrupt accepted based on interrupt levels determined for various causes of interrupts;
creating interrupt handling tasks for interrupt processing corresponding to the various causes of interrupts;
setting, in the interrupt handling tasks, task priorities reflecting the interrupt levels of the interrupts to be processed by the interrupt handling tasks created;
determining the cause of the interrupt accepted; and
activating one interrupt handling task, corresponding to the cause of interrupt determined, from among the interrupt handling tasks for which task priorities are set.

12. An interrupt control method comprising:
accepting an interrupt from an interrupt controller;
processing the interrupt accepted based on interrupt levels determined for various causes of interrupts;
creating interrupt handling tasks for interrupt processing, corresponding to the various causes of interrupts;
setting, in the interrupt handling tasks, task priorities reflecting the interrupt levels of the interrupts to be processed by the interrupt handling tasks created;
determining the cause of the interrupt accepted; and
activating one interrupt handling task, corresponding to the cause of interrupt determined, from among the interrupt handling tasks for which task priorities are set.
